(19) United States
(12) Patent Application Publication
(10) Pub. No.: US 2023/0214105 A1
(43) Pub. Date: Jul. 6, 2023

(54) MULTIMEDIA CONTENT EDITING CONTROLLER AND CONTROL METHOD THEREOF

(71) Applicant: Primax Electronics Ltd., Taipei (TW)

(72) Inventors: Yung-Tai Pan, Taipei (TW); Ming-Hsien Chiu, Taipei (TW)

(21) Appl. No.: 17/886,935

(22) Filed: Aug. 12, 2022

Related U.S. Application Data
(60) Provisional application No. 63/296,071, filed on Jan. 3, 2022.

(51) Int. Cl. G06F 3/04847; G06F 3/04817; G06F 3/0362; G06F 9/22; G06F 3/04842

(52) U.S. Cl. CPC G06F 3/04847; G06F 3/04817; G06F 3/0362; G06F 9/226; G06F 3/04842

(57) ABSTRACT

A multimedia content editing controller includes a microcontroller, a data storage device, a display device and a function selection device. The microcontroller receives plural editing function options from an external computer host. The plural editing function options are stored in the data storage device. The plural editing function options are displayed on the display device. When a user performs at least one function selection operation through the function selection device, the microcontroller determines at least one selected editing function option from the plural editing function options, and the microcontroller generates a human-machine interaction control signal. The at least one selected editing function option is transmitted from the microcontroller to the external computer host. The human-machine interaction control signal is transmitted to at least one of the display device and a LED display module.

### CROSS-REFERENCE TO RELATED APPLICATION

This application claims priority to U.S. Provisional Patent Application No. 63/296,071 filed Jan. 3, 2022, the contents of which are incorporated herein by reference.

### FIELD OF THE INVENTION

The present invention relates to a multimedia content editing controller and a control method of the multimedia content editing controller, and more particularly to a multimedia content editing controller for operating video editing software or image editing software and a control method of the multimedia content editing controller.

### BACKGROUND OF THE INVENTION

In the digital age with the rapid development of the Internet, the use of self-media as a marketing method has become the current trend. The so-called self-media marketing method is referred to a way that marketers record their own audio and video files and promote personal ideas or products through specified platforms such as Facebook, Instagram, YouTube, and so on.

Generally, image or video editing software is indispensable for implementing the self-media marketing method. For example, the image or video editing software includes iMovie, Adobe Photoshop, Adobe Premiere Pro, Movavi Video Editor or any other possible multimedia content editing software. When the image or video editing software is executed, an editing operation can be performed on the existing image or video files. Consequently, the desired image or video files can be played on the platform.

Conventionally, the user may perform various multimedia content editing operations through a user operation interface of the image or video editing software. For example, the multimedia content editing operations include special multimedia content editing operations such as a brush effect operation, an image ratio selecting operation, a video length clipping operation, a filter effect operation or a video fast forward/reverse operation. Alternatively, the multimedia content editing operations include ordinary multimedia content editing operations such as an image zooming operation or a menu selecting operation. For performing the multimedia content editing operation, the user has to operate a mouse to select a corresponding option, or the user has to press a corresponding combination key of a keyboard.

As mentioned above, the execution of the image or video editing software can provide so many kinds of multimedia content editing operations. However, the conventional technology still has some drawbacks. For example, the mouse cursor is frequently used to select various multimedia content editing operations, and the user has to memorize the screen positions of the options corresponding to various multimedia content editing operations. Alternatively, the user has to memorize the combination keys corresponding to various multimedia content editing operations. In other words, the overall editing efficiency is largely impaired. Especially, when the live streamer is live streaming, the live streamer has to quickly edit the image/video contents. The conventional multimedia content editing method is detrimental to the playback smoothness of the image/video contents during the live streaming process.

On the other hand, the conventional editing control method is usually too complicated. When the selected option corresponding to the multimedia content editing operation is clicked through the mouse cursor or the combination key, the associated procedures are only related to the one-way operation of the user. Since the associated procedures lack the human-machine interaction mechanism, misoperations usually occur. When the live streamer is live streaming, the live streamer has to edit the image/video contents in a short time. In other words, the conventional editing control method is not suitable to quickly edit image/video multimedia contents.

Therefore, it is important to provide a novel multimedia content editing controller and a control method of the multimedia content editing controller in order to increase the editing efficiency of the multimedia content and increasing the human-machine interaction efficacy.

### SUMMARY OF THE INVENTION

The present invention provides a multimedia content editing controller and a control method of the multimedia content editing controller. Consequently, the editing efficiency of the multimedia content is largely increased, and the human-machine interaction efficacy during operation is enhanced.

In accordance with an aspect of the present invention, a multimedia content editing controller is provided. The multimedia content editing controller includes a microcontroller, a data storage device, a display device and a function selection device. The microcontroller receives plural editing function options from an external computer host. The data storage device is electrically connected with the microcontroller. The plural editing function options are stored in the data storage device. The display device is electrically connected with the microcontroller. The plural editing function options are displayed on the display device. The function selection device is electrically connected with the microcontroller. When a user performs at least one function selection operation through the function selection device, the microcontroller determines at least one selected editing function option from the plural editing function options, and the microcontroller generates a human-machine interaction control signal. The at least one selected editing function option is transmitted from the microcontroller to the external computer host. The human-machine interaction control signal is transmitted to at least one of the display device and a LED display module.

In an embodiment, a multimedia content editing software is installed in the external computer host, and each of the plural editing function options is a macro editing control instruction. In response to the macro editing control instruction, the multimedia content editing software executes at least one multimedia content editing operation.

In an embodiment, a control software is installed in the external computer host. When the control software is executed, the user is permitted to self-define and edit desired editing function options for the multimedia content editing software, so that the plural editing function options are generated. The plural editing function options are further transmitted to the microcontroller.

In an embodiment, plural multimedia content editing operation icons corresponding to the plural editing function options are displayed on the display device. When the control software is executed, the user is permitted to self-define and edit icon patterns of the plural multimedia content editing operation icons.

In an embodiment, the function selection device at least includes a button module. When the user performs at least one pressing function selection operation through the button module, at least one pressing function selection signal is generated.

In an embodiment, while the at least one selected editing function option is determined in response to the at least one pressing function selection signal, the human-machine interaction control signal is displayed on the display device by the microcontroller. The human-machine interaction control signal is a highlight icon display signal corresponding to the at least one selected editing function option.

In an embodiment, the function selection device at least includes a knob module. When the user performs at least one rotating function selection operation through the knob module, at least one rotating function selection signal is generated.

In an embodiment, while the at least one selected editing function option is determined in response to the at least one rotating function selection signal, the human-machine interaction control signal is displayed on the LED display module by the microcontroller. The human-machine interaction control signal is a LED moving light display signal.

In an embodiment, a display frequency and/or a display time of the LED moving light display signal is adjustable by the microcontroller according to a rotating speed of the at least one rotating function selection operation.

In an embodiment, the knob module at least includes a knob part and an optical sensor, and the optical sensor is electrically connected with the microcontroller. When the knob part is rotated by the user and the at least one rotating function selection operation is performed, the optical sensor detects a rotation of the knob part.

In an embodiment, an electric connection path between the microcontroller and the data storage device, an electric connection path between the microcontroller and the display device and/or an electric connection path between the microcontroller and the optical sensor complies with a transmission protocol of a serial peripheral interface (SPI) bus.

In an embodiment, the multimedia content editing controller further includes a power supply module. The power supply module is electrically connected with the microcontroller. The power supply module provides a power signal to the microcontroller. The power supply module at least includes a universal serial bus port and a standalone backup power supply.

In an embodiment, the universal serial bus port is a Type-C USB port. An external power source provides electric power to the multimedia content editing controller through the universal serial bus port, and/or the plural editing function options are transmitted between the microcontroller and the external computer host through the universal serial bus port in a wired transmission manner.

In an embodiment, the multimedia content editing controller further includes at least one of an ambient light sensor and a gravity sensing device, and the ambient light sensor and the gravity sensing device are electrically connected with the microcontroller. An electric connection path between the microcontroller and the ambient light sensor and an electric connection path between the microcontroller and/or the gravity sensing device complies with a transmission protocol of an inter-integrated circuit (I²C) bus.

In an embodiment, the multimedia content editing controller further includes a wireless transmission module. The plural editing function options are transmitted between the microcontroller and the external computer host through the wireless transmission module in a wireless transmission manner.

In accordance with another aspect of the present invention, a multimedia content editing control method for a multimedia content editing controller is provided. Moreover, plural editing function options are transmitted between the multimedia content editing controller and an external computer host. The multimedia content editing control method at least includes the following steps. Firstly, at least one selected editing function option of the plural editing function options is displayed on a display device of the multimedia content editing controller. Then, a judging step is performed to judge whether at least one function selection operation corresponding to the at least one selected editing function option has been performed. If the at least one function selection operation has been performed, the at least one selected editing function option is transmitted to the external computer host, and a human-machine interaction control signal is issued to at least one of the display device and a LED display module. Then, a judging step is performed to judge whether the at least one function selection operation is not performed. If the at least one function selection operation is not performed, the human-machine interaction control signal is not issued to the at least one of the display device and the LED display module.

In an embodiment, a multimedia content editing software is installed in the external computer host, and each of the plural editing function options is a macro editing control instruction. In response to the macro editing control instruction, the multimedia content editing software executes at least one multimedia content editing operation.

In an embodiment, a control software is installed in the external computer host. When the control software is executed, the user is permitted to self-define and edit desired editing function options for the multimedia content editing software, so that the plural editing function options are generated. The plural editing function options are further transmitted to the microcontroller.

In an embodiment, plural multimedia content editing operation icons corresponding to the plural editing function options are displayed on the display device. When the control software is executed, the user is permitted to self-define and edit icon patterns of the plural multimedia content editing operation icons.

In an embodiment, the at least one function selection operation includes at least one pressing function selection operation, and the human-machine interaction control signal issued to the display device is a highlight icon display signal corresponding to the at least one selected editing function option.

In an embodiment, the at least one function selection operation includes at least one rotating function selection operation, and the human-machine interaction control signal issued to the LED display module is a LED moving light display signal.

In an embodiment, a display frequency and/or a display time of the LED moving light display signal is adjustable according to a rotating speed of the at least one rotating function selection operation.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is schematic perspective view illustrating the appearance of a multimedia content editing controller according to an embodiment of the present invention;

FIG. 2 is a schematic functional block diagram illustrating the architecture of the multimedia content editing controller as shown in FIG. 1 and the relationship between the multimedia content editing controller and an external computer host;

FIGS. 3A and 3B schematically illustrating a use scenario of the multimedia content editing controller before/after at least one pressing function selection operation is performed;

FIGS. 4A and 4B schematically illustrating another use scenario of the multimedia content editing controller before/after at least one rotating function selection operation is performed; and

FIG. 5 is a flowchart illustrating a multimedia content editing control method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

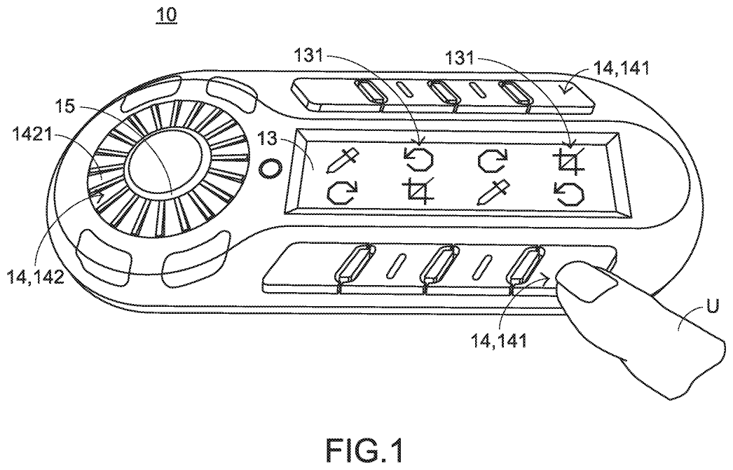

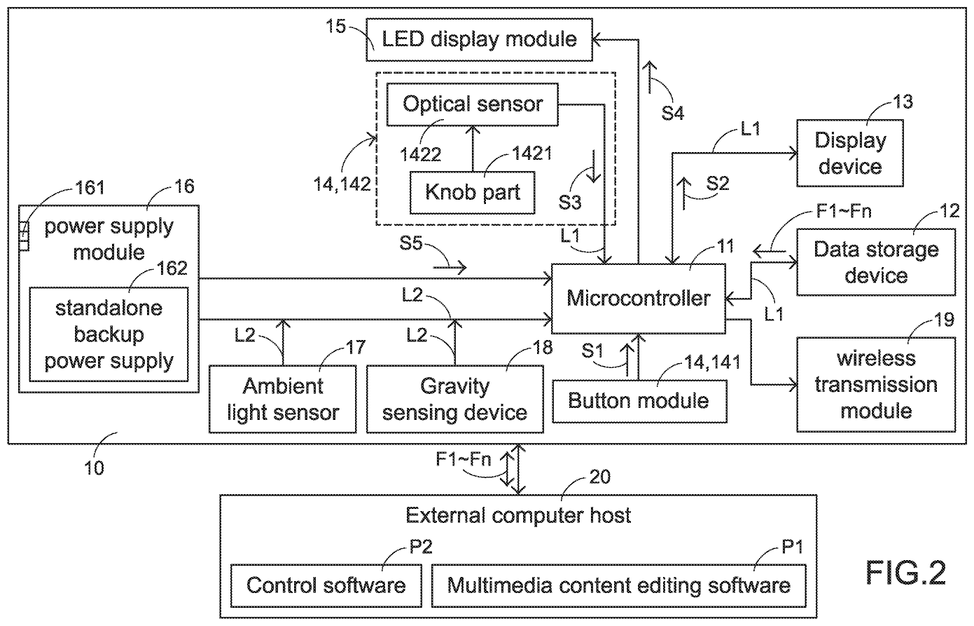

The present invention provides a multimedia content editing controller. The implementation concepts of the multimedia content editing controller of the present invention will be illustrated with reference to FIGS. 1 and 2. FIG. 1 is schematic perspective view illustrating the appearance of a multimedia content editing controller according to an embodiment of the present invention. FIG. 2 is a schematic functional block diagram illustrating the architecture of the multimedia content editing controller as shown in FIG. 1 and the relationship between the multimedia content editing controller and an external computer host.

The multimedia content editing controller 10 is electrically connected with an external computer host 20. Moreover, plural editing function options F1˜Fn can be transmitted between the multimedia content editing controller 10 and the external computer host 20. A multimedia content editing software P1 is installed in the external computer host 20. Moreover, a control software P2 for the multimedia content editing controller 10 is installed in the external computer host 20. When the multimedia content editing software P1 and the control software P2 are executed, the user U can previously edit and set the required editing function options F1˜Fn in a macro manner. Moreover, the editing function options F1˜Fn are provided to the multimedia content editing controller 10. The user U can operate the multimedia content editing controller 10 to quickly select at least one of the plural editing function options F1˜Fn. Consequently, the multimedia content editing software P1 is activated to execute at least one corresponding multimedia content editing operation.

In other words, each of the plural editing function options F1˜Fn is a macro editing control instruction. For example, the macro editing control instruction is a cursor clicking control instruction and/or a single editing control instruction corresponding to one of plural combination keys, or the macro editing control instruction is a set of plural editing control instructions. In response to the macro editing control instruction, the multimedia content editing software P1 executes the at least one corresponding multimedia content editing operation.

For example, the multimedia content editing operations include special multimedia content editing operations such as a brush effect operation, an image ratio selecting operation, a video length clipping operation, a filter effect operation or a video fast forward/reverse operation. Alternatively, the multimedia content editing operations include ordinary multimedia content editing operations such as an image zooming operation or a menu selecting operation. It is noted that the example of the multimedia content editing operation is not restricted.

When the control software P2 in the external computer host 20 is executed, the user U can self-define and edit the desired editing function options for the multimedia content editing software P1. Consequently, the editing function options F1˜Fn can be generated and transmitted to the multimedia content editing controller 10 in advance.

The multimedia content editing software P1 used in the control method of the present invention is an image or video editing software. For example, the image or video editing software includes iMovie, Adobe Photoshop, Adobe Premiere Pro, Movavi Video Editor or any other possible multimedia content editing software.

It is noted that numerous modifications and alterations may be made while retaining the teachings of the invention. For example, in another embodiment, the function of the control software P2 is integrated into the multimedia content editing software P1. That is, the function of the control software P2 and the multimedia content editing software P1 are integrated as a single software.

Please refer to FIG. 2 again. In an embodiment, the multimedia content editing controller 10 at least comprises a microcontroller 11, a data storage device 12, a display device 13 and a function selection device 14. The microcontroller 11 can receive the editing function options F1˜Fn from the external computer host 20. The data storage device 12 is electrically connected with the microcontroller 11. The editing function options F1˜Fn can be stored in the data storage device 12. The display device 13 is electrically connected with the microcontroller 11. The editing function options F1˜Fn can be displayed on the display device 13. The function selection device 14 is electrically connected with the microcontroller 11. When the user U performs at least one function selection operation through the function selection device 14, the microcontroller 11 determines a selected editing function option from the editing function options F1˜Fn. Consequently, the microcontroller 11 generates a human-machine interaction control signal.

In accordance with a feature of the present invention, the selected editing function option of the editing function options F1˜Fn is transmitted to the external computer host 20, and the human-machine interaction control signal is transmitted to at least one of the display device 13 and a LED display module 15.

An example of the data storage device 12 includes but is not limited to a flash memory. The data storage device 12 is used to store the editing function options F1˜Fn.

Moreover, at least one multimedia content editing operation icon 131 corresponding to at least one of the editing function options F1˜Fn can be displayed on the display device 13.

For example, in the embodiment of FIG. 1, eight multimedia content editing operation icons 131 in four different types are displayed on the display device 13 in order to represent eight editing function options F1˜Fn in four types. According to the eight editing function options F1˜Fn in four types, the multimedia content editing software P1 execute the corresponding multimedia content editing operations on the multimedia content. For example, the multimedia content editing operations include a brush effect operation, a video length clipping operation, an image size clipping operation, an angle rotating operation or any other appropriate multimedia content editing operation.

In some embodiments, the user U may operate the control software P2 to self-define and edit the icon patterns of the multimedia content editing operation icons 131. Consequently, the icon patterns of the multimedia content editing operation icons 131 may be different. In other words, more different editing function options can be defined. Consequently, the multimedia content editing software P1 can be controlled to execute more multimedia content editing operations.

In an embodiment, the display device 13 is a non-touch screen. It is noted that the example of the display device 13 is not restricted. For example, in another embodiment, the display device 13 is a touch screen. Under this circumstance, the user U can directly touch the selected multimedia content editing operation icon on the display device in order to control the multimedia content editing software P1 to quickly implement the corresponding multimedia content editing operation.

The function selection device 14 is electrically connected with the microcontroller 11. The function selection device 14 at least comprises two selection modules for providing the user U to perform different function selection operations. For example, the function selection device 14 at least comprises a button module 141 and a knob module 142.

For well understanding the concepts of the present invention, two use scenarios of the multimedia content editing controller 10 will be described as follows.

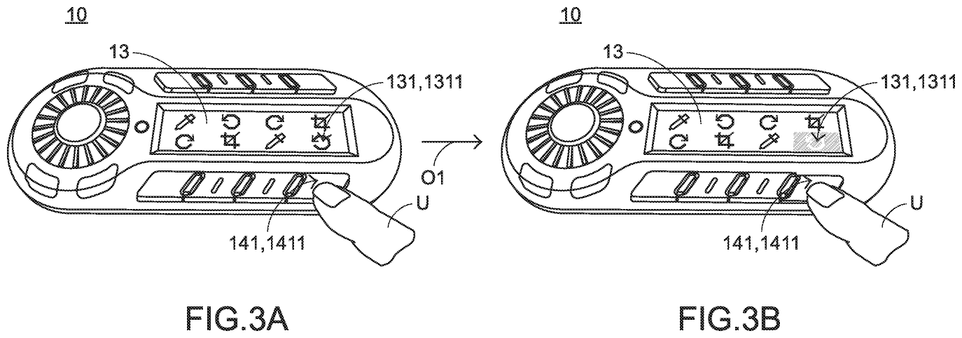

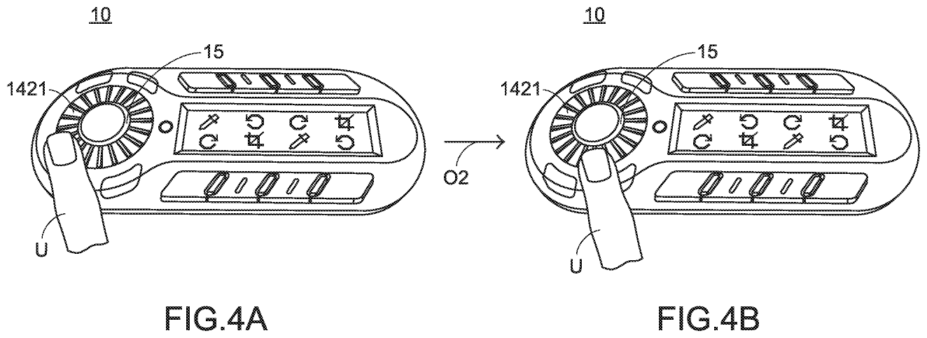

FIGS. 3A and 3B schematically illustrating a use scenario of the multimedia content editing controller before/after at least one pressing function selection operation is performed. FIGS. 4A and 4B schematically illustrating another use scenario of the multimedia content editing controller before/after at least one rotating function selection operation is performed.

Please refer to FIGS. 1, 2, 3A and 3B. In an embodiment, the button module 141 comprises plural single buttons. For example, as shown in FIG. 1, the button module 141 comprises eight buttons corresponding to the eight multimedia content editing operation icons 131. When a single button is pressed down by the user U, a pressing function selection operation O1 of the plural different function selection operations is performed. Consequently, a pressing function selection signal S1 is generated.

Please refer to FIG. 3A. In case that the single button 1411 of the button module 141 at the bottom right corner is not pressed down by the user U, a single multimedia content editing operation icon 1311 at the bottom right corner of the display device 13 is in a normal display status.

Please refer to FIG. 3B. When the single button 1411 is pressed down and the pressing function selection operation O1 is performed, the button module 141 generates the pressing function selection signal S1 to the microcontroller 11. In response to the pressing function selection signal S1, the microcontroller 11 determines at least one selected editing function option from the editing function options F1˜Fn. While the at least one selected editing function option is determined and transmitted, the human-machine interaction control signal is displayed on the corresponding single multimedia content editing operation icon 1311. As shown in FIG. 2, the human-machine interaction control signal represents a highlight icon display signal S2. As shown in, FIG. 3B, a highlight icon display effect is generated at the single multimedia content editing operation icon 1311. Due to the human-machine interaction control signal, the user U can confirm whether the selected multimedia content editing operation icon 1311 is relevant to the corresponding editing function option.

When the single button 1411 is no longer pressed by the user U and the pressing function selection operation O1 is not performed, the single multimedia content editing operation icon 1311 at the bottom right corner of the display device 13 is restored to the normal display status.

Please refer to FIGS. 1, 2, 4A and 4B. In an embodiment, the knob module 142 at least comprises a knob part 1421 and an optical sensor 1422. The optical sensor 1422 is electrically connected with the microcontroller 11. When the knob part 1421 is rotated by the user U and a rotating function selection operation O2 of the plural different function selection operations is performed, the optical sensor 1422 detects the rotation of the knob part 1421. Consequently, a rotating function selection signal S3 is generated.

Please refer to FIG. 4A. In case that the knob part 1421 is not rotated by the user U, the LED display module 15 (e.g., a ring-shaped LED display module) does not generate any LED light beam.

Please refer to FIG. 4B. When the knob part 1421 is rotated by the user U, the optical sensor 1422 generates the rotating function selection signal S3 to the microcontroller 11. In response to the rotating function selection signal S3, the microcontroller 11 determines at least one selected editing function option from the editing function options F1˜Fn. While the at least one selected editing function option is determined, the microcontroller 11 issues a human-machine interaction control signal to the LED display module 15. As shown in FIG. 2, the human-machine interaction control signal represents a LED moving light display signal S4. As shown in FIG. 4B, the human-machine interaction control signal represents a human-machine interaction effect that a LED light beam at the LED display module 15 is synchronously rotated with the rotation of the knob part 1421.

Preferably, according to a rotating speed of the rotating function selection operation O2, the microcontroller 11 adjusts a display frequency and/or a display time of the LED moving light display signal S4. Consequently, the better human-machine interaction efficacy can be provided, and the user U can better understand the subtle operation status when the rotating function selection operation O2 is performed by himself/herself.

When the knob part 1421 is no longer rotated by the user U and the rotating function selection operation O2 is not performed, the display module 15 stops emitting the LED light beam.

In accordance with another feature, the technology of the present invention can prevent from the generation of afterimages when the multimedia content editing operation icons 131 are displayed on the display device 13. In an implementation example, the electric connection path L1 between the microcontroller 11 and the data storage device 12, the electric connection path L1 between the microcontroller 11 and the display device 13 and/or the electric connection path L1 between the microcontroller 11 and the optical sensor 1422 is a high speed transmission interface. For example, the high speed transmission interface complies with the transmission protocol of a serial peripheral interface (SPI) bus. Consequently, the displaying efficacy is further enhanced.

Please refer to FIG. 2 again. In an embodiment, the multimedia content editing controller 10 further comprises a power supply module 16. The power supply module 16 is electrically connected with the microcontroller 11. The power supply module 16 provides a power signal S5 to the microcontroller 11. In an embodiment, the power supply module 16 at least comprises a universal serial bus (USB) port 161 and a standalone backup power supply 162.

Preferably, the USB port 161 is a Type-C USB port. Through the USB port 161, an external power source (not shown) can provide electric power to the multimedia content editing controller 10. Furthermore, the editing function options F1˜Fn can be transmitted between the microcontroller 11 and the external computer host 20 through the USB port 161 in a wired transmission manner.

Optionally, the multimedia content editing controller 10 further comprises at least one of an ambient light sensor 17 and a gravity sensing device 18. The ambient light sensor 17 and the gravity sensing device 18 are electrically connected with the microcontroller 11. The electric connection path L2 between the microcontroller 11 and the ambient light sensor 17 and the electric connection path L2 between the microcontroller 11 and the gravity sensing device 18 comply with the transmission protocol of an inter-integrated circuit (I²C) bus.

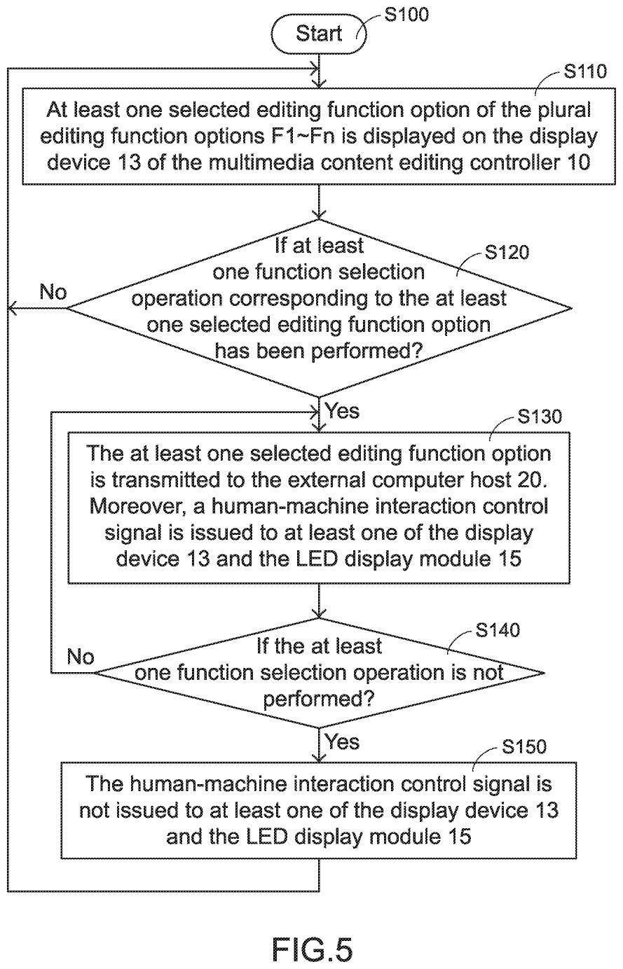

Please refer to FIG. 2 again. In an embodiment, the multimedia content editing controller 10 further comprises a wireless transmission module 19. The editing function options F1˜Fn can be transmitted between the microcontroller 11 and the external computer host 20 through the wireless transmission module 19 in a wireless transmission manner. The components and functions of the multimedia content editing controller 10 have been described in FIGS. 1 to 4B. FIG. 5 is a flowchart illustrating a multimedia content editing control method according to an embodiment of the present invention. The multimedia content editing control method is applied to the multimedia content editing controller 10. Moreover, plural editing function options F1˜Fn can be transmitted between the multimedia content editing controller 10 and the external computer host 20. The multimedia content editing control method at least comprises the following steps.

In a step S100, the flowchart is started.

In a step S110, at least one selected editing function option of the plural editing function options F1˜Fn is displayed on the display device 13 of the multimedia content editing controller 10.

Then, a step S120 is performed to judge whether at least one function selection operation corresponding to the at least one selected editing function option has been performed. If the judging condition of the step S120 is not satisfied, the step S110 is repeatedly done.

If the judging result of the step S120 indicates that the at least one function selection operation corresponding to the at least one selected editing function option has been performed, a step S130 is performed. In the step S130, the at least one selected editing function option is transmitted to the external computer host 20. Moreover, a human-machine interaction control signal is issued to at least one of the display device 13 and the LED display module 15.

Then, a step S140 is performed to judge whether the at least one function selection operation is not performed. If the judging condition of the step S140 is not satisfied, the step S130 is repeatedly done.

If the judging result of the step S120 indicates that the at least one function selection operation is not performed, the human-machine interaction control signal is not issued to the at least one of the display device 13 and the LED display module 15. Then, the step S110 is repeatedly done.

Moreover, a multimedia content editing software P1 is installed in the external computer host 20. Each of the plural editing function options F1˜Fn is a macro editing control instruction. In response to the macro editing control instruction, the multimedia content editing software P1 executes at least one multimedia content editing operation.

Preferably, a control software P2 is also installed in the external computer host 20. When the control software P2 is executed, the user U can self-define and edit the desired editing function options for the multimedia content editing software P1. Consequently, the editing function options F1˜Fn can be generated and transmitted to the multimedia content editing controller 10.

Moreover, at least one multimedia content editing operation icon 131 corresponding to at least one of the editing function options F1˜Fn can be displayed on the display device 13. The user U may operate the control software P2 to self-define and edit the icon patterns of the multimedia content editing operation icons 131.

In an embodiment, the at least one function selection operation includes at least one pressing function selection operation O1, and the human-machine interaction control signal transmitted to the display device 13 is a highlight icon display signal S2 corresponding to the selected editing function option.

In another embodiment, the at least one function selection operation includes at least one rotating function selection operation O2, and the human-machine interaction control signal transmitted to the LED display module 15 is a LED moving light display signal S4. Moreover, according to a rotating speed of the rotating function selection operation O2, the microcontroller 11 can adjust a display frequency and/or a display time of the LED moving light display signal S4.

From the above descriptions, the present invention provides a multimedia content editing controller and a control method of the multimedia content editing controller. By the multimedia content editing controller and the control method of the present invention, the editing efficiency of the multimedia content is increased and the human-machine interaction efficacy during operation is enhanced. In other words, the multimedia content editing controller and the control method of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A multimedia content editing controller, comprising:
a microcontroller receiving plural editing function options from an external computer host;
a data storage device electrically connected with the microcontroller, wherein the plural editing function options are stored in the data storage device;
a display device electrically connected with the microcontroller, wherein the plural editing function options are displayed on the display device; and
a function selection device electrically connected with the microcontroller, wherein when a user performs at least one function selection operation through the function selection device, the microcontroller determines at least one selected editing function option from the plural editing function options, and the microcontroller generates a human-machine interaction control signal,
wherein the at least one selected editing function option is transmitted from the microcontroller to the external computer host, and the human-machine interaction control signal is transmitted to at least one of the display device and a LED display module.

2. The multimedia content editing controller according to claim 1, wherein a multimedia content editing software is installed in the external computer host, and each of the plural editing function options is a macro editing control instruction, wherein in response to the macro editing control instruction, the multimedia content editing software executes at least one multimedia content editing operation.

3. The multimedia content editing controller according to claim 2, wherein a control software is installed in the external computer host, wherein when the control software is executed, the user is permitted to self-define and edit desired editing function options for the multimedia content editing software, so that the plural editing function options are generated, wherein the plural editing function options are further transmitted to the microcontroller.

4. The multimedia content editing controller according to claim 2, wherein plural multimedia content editing operation icons corresponding to the plural editing function options are displayed on the display device, wherein when the control software is executed, the user is permitted to self-define and edit icon patterns of the plural multimedia content editing operation icons.

5. The multimedia content editing controller according to claim 4, wherein the function selection device at least comprises a button module, wherein when the user performs at least one pressing function selection operation through the button module, at least one pressing function selection signal is generated.

6. The multimedia content editing controller according to claim 5, wherein while the at least one selected editing function option is determined in response to the at least one pressing function selection signal, the human-machine interaction control signal is displayed on the display device by the microcontroller, wherein the human-machine interaction control signal is a highlight icon display signal corresponding to the at least one selected editing function option.

7. The multimedia content editing controller according to claim 4, wherein the function selection device at least comprises a knob module, wherein when the user performs at least one rotating function selection operation through the knob module, at least one rotating function selection signal is generated.

8. The multimedia content editing controller according to claim 7, wherein while the at least one selected editing function option is determined in response to the at least one rotating function selection signal, the human-machine interaction control signal is displayed on the LED display module by the microcontroller, wherein the human-machine interaction control signal is a LED moving light display signal.

9. The multimedia content editing controller according to claim 8, wherein a display frequency and/or a display time of the LED moving light display signal is adjustable by the microcontroller according to a rotating speed of the at least one rotating function selection operation.

10. The multimedia content editing controller according to claim 7, wherein the knob module at least comprises a knob part and an optical sensor, and the optical sensor is electrically connected with the microcontroller, wherein when the knob part is rotated by the user and the at least one rotating function selection operation is performed, the optical sensor detects a rotation of the knob part.

11. The multimedia content editing controller according to claim 10, wherein an electric connection path between the microcontroller and the data storage device, an electric connection path between the microcontroller and the display device and/or an electric connection path between the microcontroller and the optical sensor complies with a transmission protocol of a serial peripheral interface (SPI) bus.

12. The multimedia content editing controller according to claim 1, wherein the multimedia content editing controller further comprises a power supply module, wherein the power supply module is electrically connected with the microcontroller, and the power supply module provides a power signal to the microcontroller, wherein the power supply module at least comprises a universal serial bus port and a standalone backup power supply.

13. The multimedia content editing controller according to claim 12, wherein the universal serial bus port is a Type-C USB port, wherein an external power source provides electric power to the multimedia content editing controller through the universal serial bus port, and/or the plural editing function options are transmitted between the microcontroller and the external computer host through the universal serial bus port in a wired transmission manner.

14. The multimedia content editing controller according to claim 1, wherein the multimedia content editing controller further comprises at least one of an ambient light sensor and a gravity sensing device, and the ambient light sensor and the gravity sensing device are electrically connected with the microcontroller, wherein an electric connection path between the microcontroller and the ambient light sensor and an electric connection path between the microcontroller and/or the gravity sensing device complies with a transmission protocol of an inter-integrated circuit (I²C) bus.

15. The multimedia content editing controller according to claim 1, wherein the multimedia content editing controller further comprises a wireless transmission module, wherein the plural editing function options are transmitted between the microcontroller and the external computer host through the wireless transmission module in a wireless transmission manner.

16. A multimedia content editing control method for a multimedia content editing controller, plural editing function options being transmitted between the multimedia content editing controller and an external computer host, the multimedia content editing control method at least comprising steps of:
displaying at least one selected editing function option of the plural editing function options on a display device of the multimedia content editing controller;
judging whether at least one function selection operation corresponding to the at least one selected editing function option has been performed;
if the at least one function selection operation has been performed, transmitting the at least one selected editing function option to the external computer host, and issuing a human-machine interaction control signal to at least one of the display device and a LED display module;
judging whether the at least one function selection operation is not performed; and
if the at least one function selection operation is not performed, stopping issuing the human-machine interaction control signal to the at least one of the display device and the LED display module.

17. The multimedia content editing control method according to claim 16, wherein a multimedia content editing software is installed in the external computer host, and each of the plural editing function options is a macro editing control instruction, wherein in response to the macro editing control instruction, the multimedia content editing software executes at least one multimedia content editing operation.

18. The multimedia content editing control method according to claim 17, wherein a control software is installed in the external computer host, wherein when the control software is executed, the user is permitted to self-define and edit desired editing function options for the multimedia content editing software, so that the plural editing function options are generated, wherein the plural editing function options are further transmitted to the microcontroller.

19. The multimedia content editing control method according to claim 18, wherein plural multimedia content editing operation icons corresponding to the plural editing function options are displayed on the display device, wherein when the control software is executed, the user is permitted to self-define and edit icon patterns of the plural multimedia content editing operation icons.

20. The multimedia content editing control method according to claim 19, wherein the at least one function selection operation includes at least one pressing function selection operation, and the human-machine interaction control signal issued to the display device is a highlight icon display signal corresponding to the at least one selected editing function option.

21. The multimedia content editing control method according to claim 19, wherein the at least one function selection operation includes at least one rotating function selection operation, and the human-machine interaction control signal issued to the LED display module is a LED moving light display signal.

22. The multimedia content editing control method according to claim 21, wherein a display frequency and/or a display time of the LED moving light display signal is adjustable according to a rotating speed of the at least one rotating function selection operation.
